(19) United States
(12) Patent Application Publication
(10) Pub. No.: US 2016/0285921 A1
(43) Pub. Date: Sep. 29, 2016

(54) TECHNIQUES FOR ORGANIZING PARTICIPANT INTERACTION DURING A COMMUNICATION SESSION

(71) Applicant: Cisco Technology, Inc., San Jose, CA (US)

(72) Inventors: Denis Savostiyanov, Feltham (GB); Andrew Henderson, Galway (IE)

(21) Appl. No.: 14/665,809

(22) Filed: Mar. 23, 2015

(51) Int. Cl. H04L 29/06

(52) U.S. Cl. CPC H04L 65/1059; H04L 65/4038

(57) ABSTRACT

In one embodiment, a device (e.g., a host device) receives an interaction request from at least one participant device during a communication session between a plurality of devices, and assigns a position in a participant queue to each participant device. The device further provides information regarding the participant queue to one or more of the plurality of devices to cause each of the one or more devices to display the participant queue including each participant device indexed according to the assigned position. The device further permits at least one participant device to interact with the plurality of devices of the communication session according to the assigned position in the participant queue.

### TECHNICAL FIELD

The present disclosure relates generally to communication systems, and more particularly, to techniques for organizing participant interaction during a real-time communication session.

### BACKGROUND

Communication technologies connect an ever increasing number of people using various types of networks, protocols, devices, and the like, and provide a platform for real-time collaboration amongst multiple users regardless of geographic location. Examples of such communication technologies include conference calls, conference bridges, desktop sharing programs, real-time video conferencing, and the like.

However, these various communication technologies often lack structure or organization and may, at times, result in confusion during real-time collaboration when users interrupt each other, speak over each other, and the like. For example, during a conference call, two users may attempt to participate or interact with the conference call attendees at the same time. This unorganized interaction may be due, in part, to a user being unaware when a current speaker is finished interacting (e.g., misinterpreting a pause, etc.), two or more users initiating interaction at the same time, and various other reasons.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example communication network;

FIG. 2 illustrates an example network device/node;

FIG. 3 illustrates an example view of a device employing techniques for organizing participant interaction during a real-time communication session, according to one embodiment of this disclosure;

FIG. 4 illustrates an example view of the device shown in FIG. 3, particularly from the perspective of a host user device;

FIG. 5 illustrates an example view of a device employing techniques for organizing participant interaction during a real-time communication session according to another embodiment of this disclosure;

FIG. 6 illustrates an example view of the device shown in FIG. 5, further showing an attendee area of user devices;

FIG. 7 illustrates an example view of the device shown in FIG. 5, further showing a participant queue for participant user devices;

FIG. 8 illustrates an example view of the device shown in FIG. 5, further showing an interaction notification for permitted interaction, and an optional timer feature for participant user devices;

FIG. 9 illustrates an example view of the device techniques shown in FIG. 5, particularly from the perspective of a host user device;

FIG. 10 illustrates an example simplified procedure for organizing participant interaction during a real-time communication session; and

FIG. 11 illustrates another example simplified procedure for organizing participant interaction during a real-time communication session.

An element or functionally similar element is indicated with the same reference number.

### DESCRIPTION OF EXAMPLE EMBODIMENTS

Overview

The present technology pertains to presenting and interacting with any networked appliance in an environment. For example, according to one or more embodiments of the disclosure, a device such as a host device receives an interaction request during the communication to yield at least one participant device, and assigns a position in a participant queue to each participant device. The device further provides information regarding the participant queue to one or more of the plurality of devices to cause each of the one or more devices to display the participant queue including each participant device indexed according to the assigned position, and permits at least one participant device to interact with the plurality of devices of the communication session according to the assigned position in the participant queue.

Description

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

As used herein, the term “user” shall be considered to mean a user of an electronic device(s). Moreover, in certain instances the term user is used interchangeable with a corresponding “user device” with actions performed by a user in the context of computer software or programmable media to be considered as actions taken by a user to provide an input to the user device (e.g., electronic device(s)) to cause the user device to perform the steps embodied in computer software. In other instances a user can also refer to a user account associated with a particular electronic device.

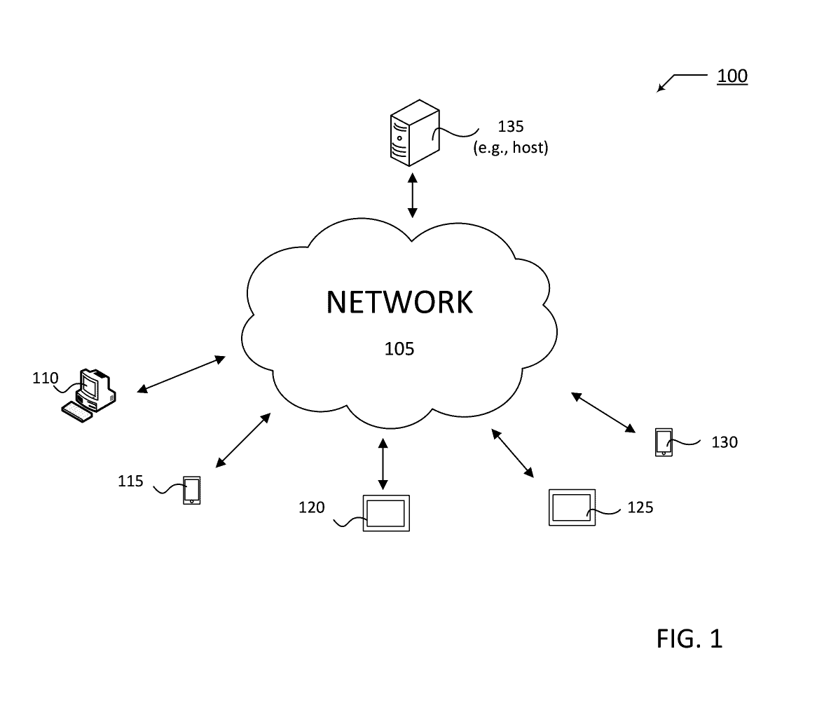

FIG. 1 is a schematic block diagram of an example communication environment 100 illustratively comprising devices, labeled as shown, device 110, device 115, device 120, device 125, device 130, and device 135 interconnected by various methods of communication in a network 105. Notably, certain devices, such as a “host” device 135, can host or establish the communication session and/or may have certain additional permissions over other non-host devices. Network 105 represents a geographically distributed collection of devices interconnected by links and segments for transporting data between end nodes, such as computers, workstations, mobile devices, tablets, or other devices as is appreciated by those skilled in the art. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links Network 105 can include LANs, WANs, and various other types of networks, as is appreciated by those skilled in the art.

With respect to the communication links, the links may be may be wired links or shared media (e.g., wireless links, power line communication links, etc.) where certain devices may be in communication with other devices, e.g., based on distance, signal strength, current operational status, location, etc. Further, those skilled in the art will also understand that any number of nodes, devices, links, etc. may be used in the communication environment 100, and that the view shown herein is for simplicity. Also, those skilled in the art will further understand that while the network 105 is shown in a certain orientation—e.g., with each device communicating directly with network 105—such orientation is merely provide for purposes of illustration, not limitation and various other type of network orientations can also employ the techniques described herein.

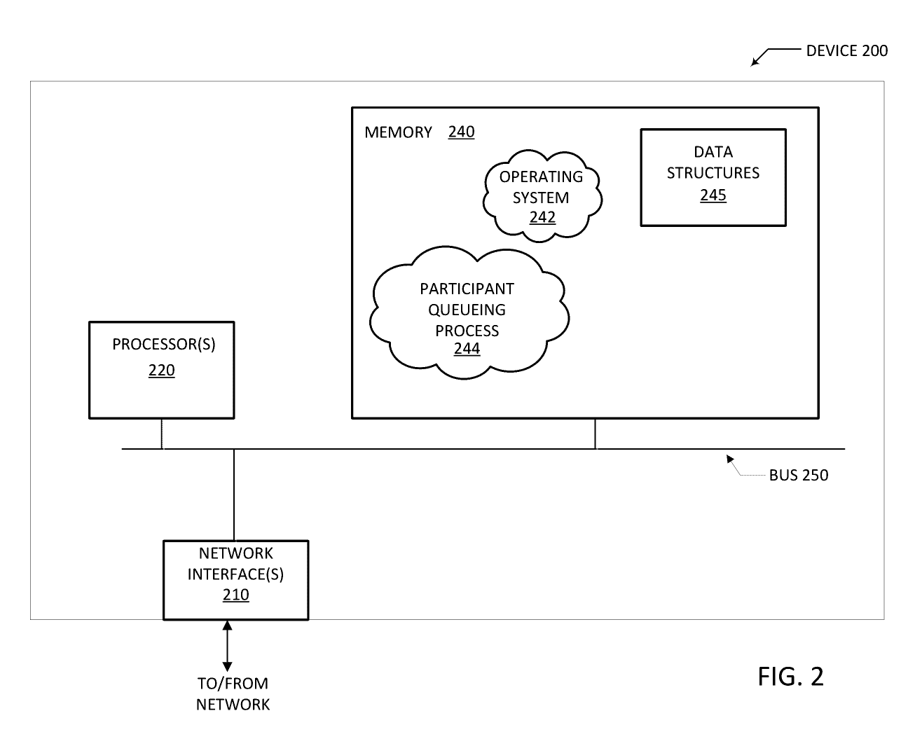

FIG. 2 is a schematic block diagram of an example device 200 that may be used with one or more embodiments described herein, e.g., as any of the devices shown in FIG. 1 above. The device 200 may comprise one or more network interfaces 210 (e.g., wired, wireless, etc.), at least one processor 220, and a memory 240 interconnected by a system bus 250.

Network interface(s) 210 contain the mechanical, electrical, and signaling circuitry for communicating data to/from the network 105. The network interfaces may be configured to transmit and/or receive data using a variety of different communication protocols.

Memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). Processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise participant queueing process/services 244 (e.g., an automated queueing process), which are executed by the processor 220 to perform functions as described herein.

It will be apparent to those skilled in the art that other processor and memory types, including various tangible, non-transitory, computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

As noted above, certain real-time collaboration using conventional technologies often lacks structure or organization, which may lead to confusion when, for example, multiple users speak out of turn, at the same time, or over each other. Thus, for various real-time collaboration technologies, there is an absence of organization or structure that can allow users to interact in an orderly manner, allowing a next user to interact when a current user is finished.

Accordingly, the techniques described herein organize participant interaction during a real-time communication session and provide, in part, an automated participant queueing process/service that enables participants to interact with attendees (of the communication session) in an orderly and organized manner. Such techniques may, for example, permit a participant device to interact with attendees according to a corresponding position in a participant queue (e.g., when it is the particular user's “turn”). While certain embodiments include processes that may be automated, other embodiments support manual management of the participant queue by users (e.g., a host user). As discussed in greater detail herein, these techniques may be performed by hardware, software, and/or firmware, such as in accordance with the “participant queueing” process 244, which may contain computer executable instructions executed by the processor 220 (or independent processor of interfaces 210) to perform functions relating to these techniques.

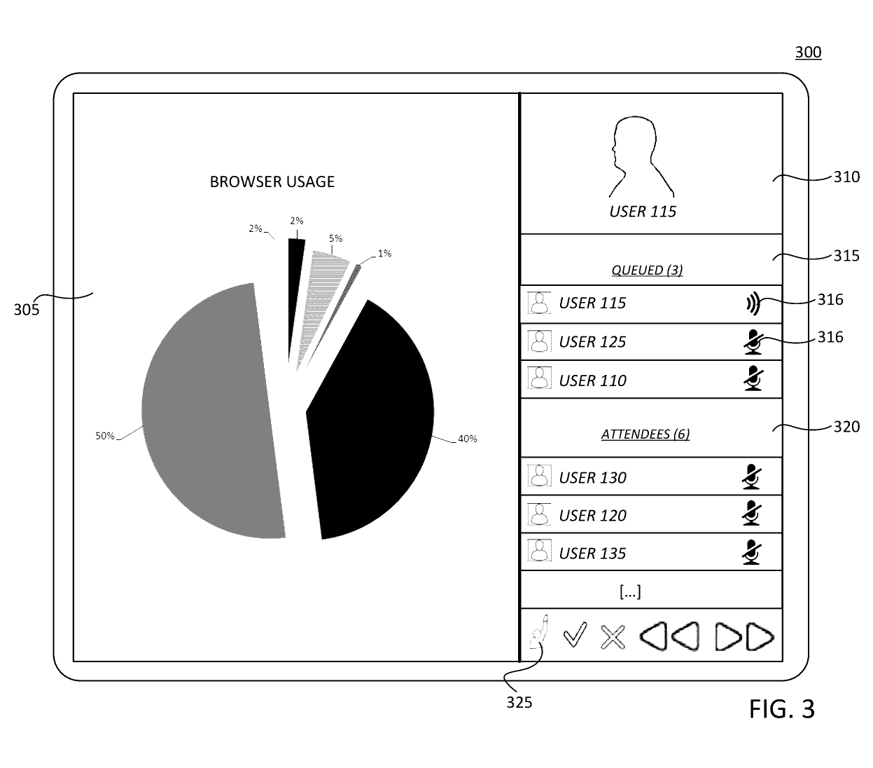

Referring now to FIG. 3, aspects or features of one embodiment of the organization techniques are shown in an example view 300, particularly from the perspective of a user device attending a real-time communication session (e.g., one of the devices shown in FIG. 1). According to this embodiment, the real-time communication session may include a desktop sharing process/service (e.g., Cisco WebEx, etc.)

View 300 includes a shared display area 305 showing portions of a shared-desktop screen, an image area 310 showing an avatar of a user, or a real-time video of a currently interacting user, a queue area 315 including a participant queue, and an attendee area 320.

The queue area 315 provides a list of users indexed in respective positions in the participant queue. Typically, users submit a participant request to the automated queuing process, which subsequently assigns the user (e.g., a “participant device”) a position on the participant queue. As shown, the participant queue also shows a currently interacting participant device—e.g., user 115.

The attendee area 320 provides a list of attending users/devices for the communication session. The attendee area 320 and queue area 315 further include notifications or indications 316 representing when interaction is permitted for a user/device during the communication session—e.g., represented by a “mute” icon, an “un-mute” icon, and the like.

View 300 also shows a participant request feature 325, represented by a person raising a hand. As discussed in greater detail herein, a user can request to participate during the communication session, using the participate request feature 325, which results in the user becoming a “participant” and subsequent placement in the queue area 315.

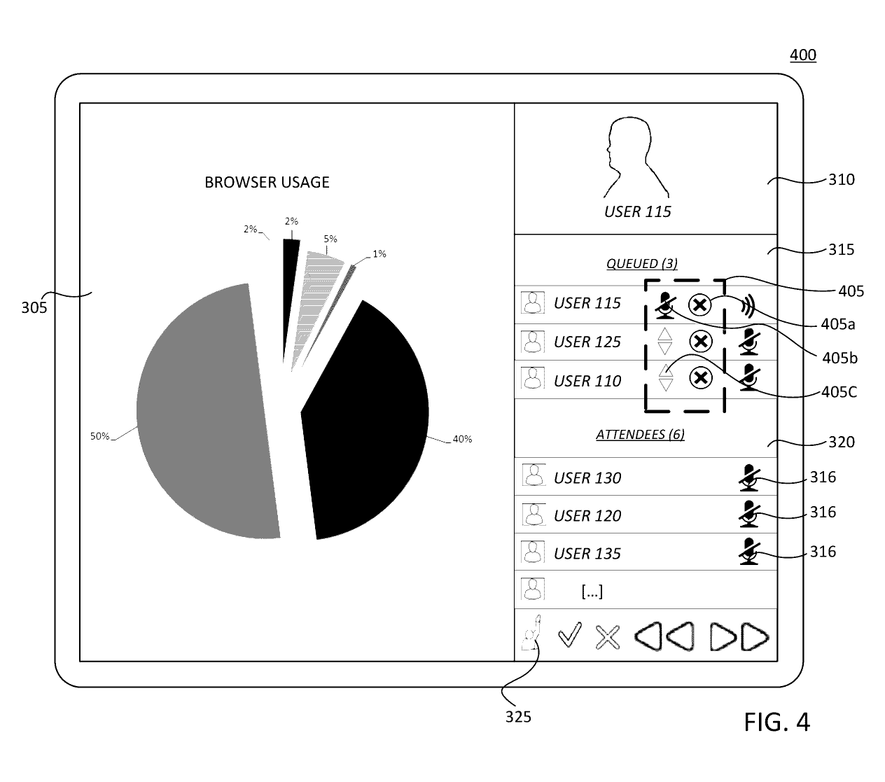

FIG. 4 illustrates an example view 400 of the device shown in FIG. 3, particularly from the perspective of a host device—e.g., host device 135 (shown in FIG. 1). View 400 includes the above discussed features of a non-host device, and further includes host permission features or elements 405. These host permission features 405 include, for example, “remove” 405a, “interact” 405b, “queue position adjust” 405c. As shown, a host user, using a host device, may manipulate the queue area 315, by, for example, removing certain participant devices (via remove 405a), muting or un-muting participant devices in the queue (via interact 405b) to permit or prohibit interaction for the corresponding participant device, and adjust a position assigned to participant devices in the queue (via queue position adjust 405c) to move a participant up or down the queue. These host permission features 405 particularly include the above discussed features, however, such features are provided for illustration, not limitation. The host permission features 405 can also include any number of additional features as is understood by those skilled in the art.

Referring collectively to FIGS. 3 and 4, the real-time communication techniques include an automated participant queueing process that enables users to participate in an orderly and organized manner—namely, permitted or prohibited interaction during the communication session according to the participant queue shown in queue area 315. Operatively, host device 135 establishes a communication session for a plurality of devices/users or “attendees”. The automated queuing process assigns requesting devices (participant devices 110, 120, and 115) to a position in the participant queue, shown in queue area 315. Typically, a participant device submits the participant request to the automated participant queueing process, and is thereafter assigned to a position in the participant queue. For example, the assigned position may be behind (or “below”) the current last-in-line participant device in the participant queue. As shown in FIGS. 3 and 4, the participant devices are indexed and displayed according to respective assigned positions in the participant queue, with the “top” or “first” participant device being user 115, and a “next” or “second” participant device being user 125, and so on.

In certain other embodiments, the queue position may be assigned using a weighting. For example, in these certain other embodiments, the assigned position in the queue can factor in or account for a total interaction time of a user and corresponding user device, a number of interactions (e.g., a number of times placed in queue), a subject matter of the communication session and a relationship to a user (e.g., authorship for the presented topic, whether the user is a main presenter, etc.), a position within a company (e.g., according to an organizational chart or corporate hierarchy/structure for users, etc.), and the like.

The queue area 315 may also be provided for display to all of the attendees, or only a specified subset thereof—e.g., only participant devices in the participant queue. For example, in response to a participant request (e.g., from a device selecting the participant request feature 325), the queue area 315, including the participant queue, may be provided for display by the requesting participant device. The participant queue may also be updated continuously as participant devices ends a respective turn (e.g., ceasing interaction with the attendees for a period of time, upon receipt of an interaction termination notification from the corresponding participant device, etc.)

Generally, the automated participant queueing process permits or prohibits interaction for each participant device according to the assigned position in the queue. For example, as discussed above, when the participant devices moves to the top or first position of the participant queue (or if there are no other participant devices in the queue), the participant device is permitted to interact (e.g., un-muted) with the attendees. Additionally, as discussed above, optional host permissions may be used to manipulate the automated participant queueing process, or even manually manage the participant queue.

Moreover, although the views shown in FIGS. 3 and 4 illustrate a single participant device interacting with the attendees—namely, user/device 115, the participant queue can be configured to permit or prohibit any number of users to interact with the attendees at a particular time.

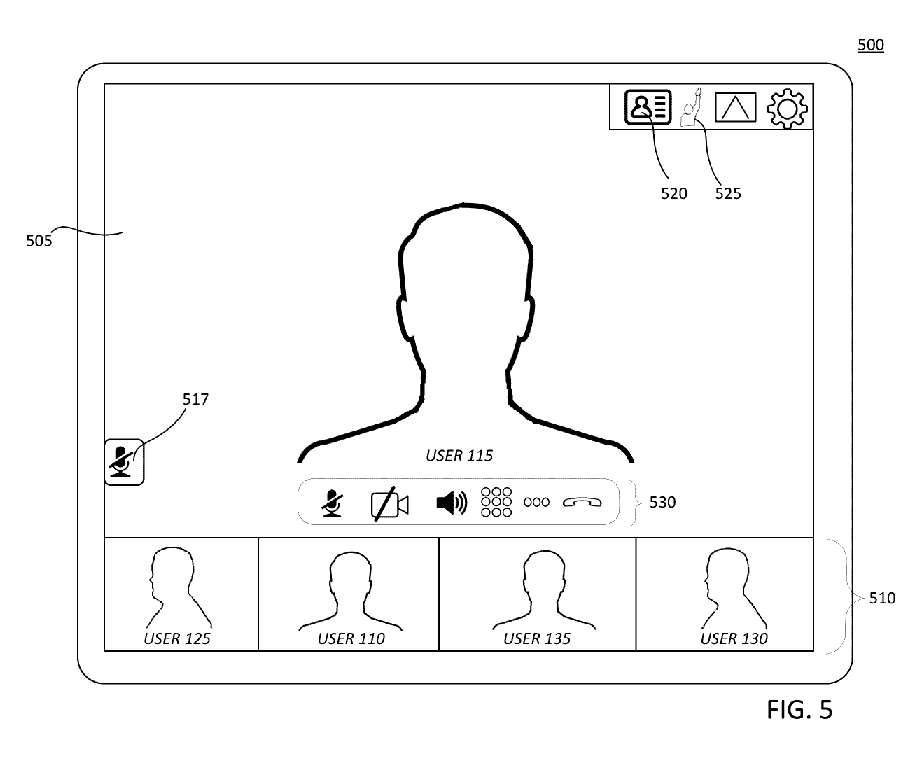

FIG. 5 provides an example view 500 of a device employing techniques for organizing participant interaction during a real-time communication session according to another embodiment of this disclosure. As shown, view 500 illustrates a real-time video conference. In addition, view 500, similar to view 400, includes a shared display area 505 showing a real-time video display of a currently interacting participant (user 115), an image area 510 showing corresponding avatars of attendees—users 125, user 110, user 130, and user 135, a participant request feature 525, and an interaction notification 517 representing when the user is permitted to interact with attendees. View 500 further includes an attendee list feature 520, as well as various user features 530. As discussed in greater detail below, an attendee list, participant queue, and other elements are hidden from default display, until a user interacts with a corresponding feature (e.g., a participant request feature 525, an attendee list feature 520, etc.)

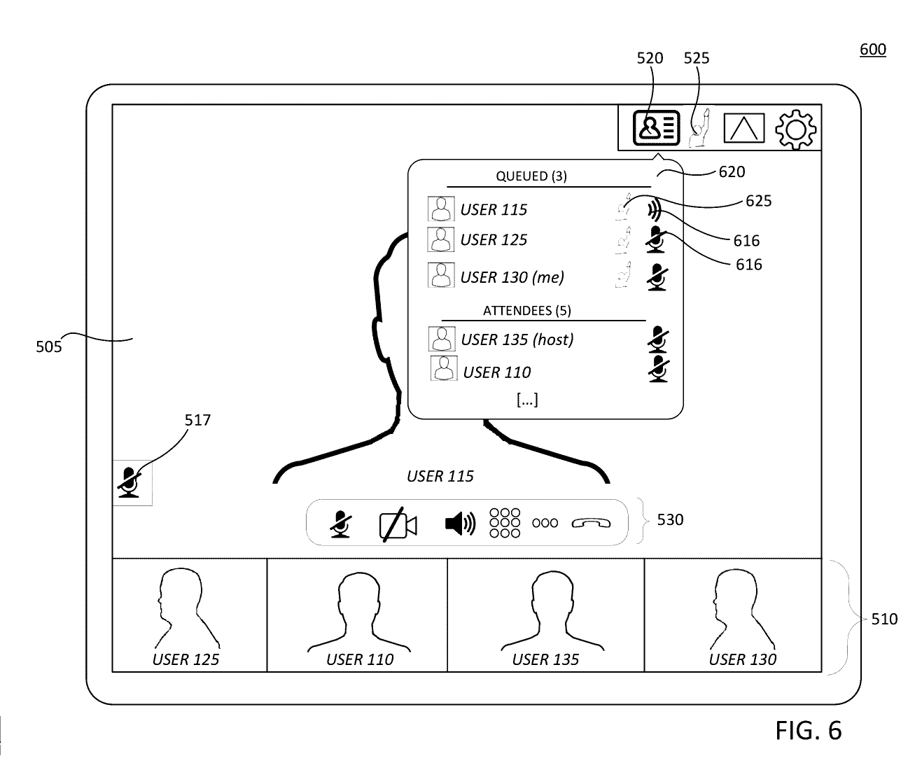

FIG. 6 illustrates an example view 600 of the device shown in FIG. 5, further displaying an attendee list 620. Operatively, a user selects the attendee list feature 520, which opens the attendee list 620 to display each device attending the communication session. In addition to displaying each device attending the communication session, attendee list 620 includes a queued portion similar to the queue area 315 shown in FIG. 3. Further, attendee list 620 also includes notifications 616, similar to notifications 316, associated with respective devices to represent when interaction is permitted or prohibited. For example, as shown, one of notifications 616 (e.g., associated with user 115) indicates permitted interaction with the attendees of the communication session, while other notifications 616 (e.g., associated with users 125, 110, 130, and 135) indicate interaction is not permitted. Attendee list 620 also includes a participant queue notification 625 associated with respective devices to represent when the respective device is assigned a position in a participant queue, discussed in greater detail below.

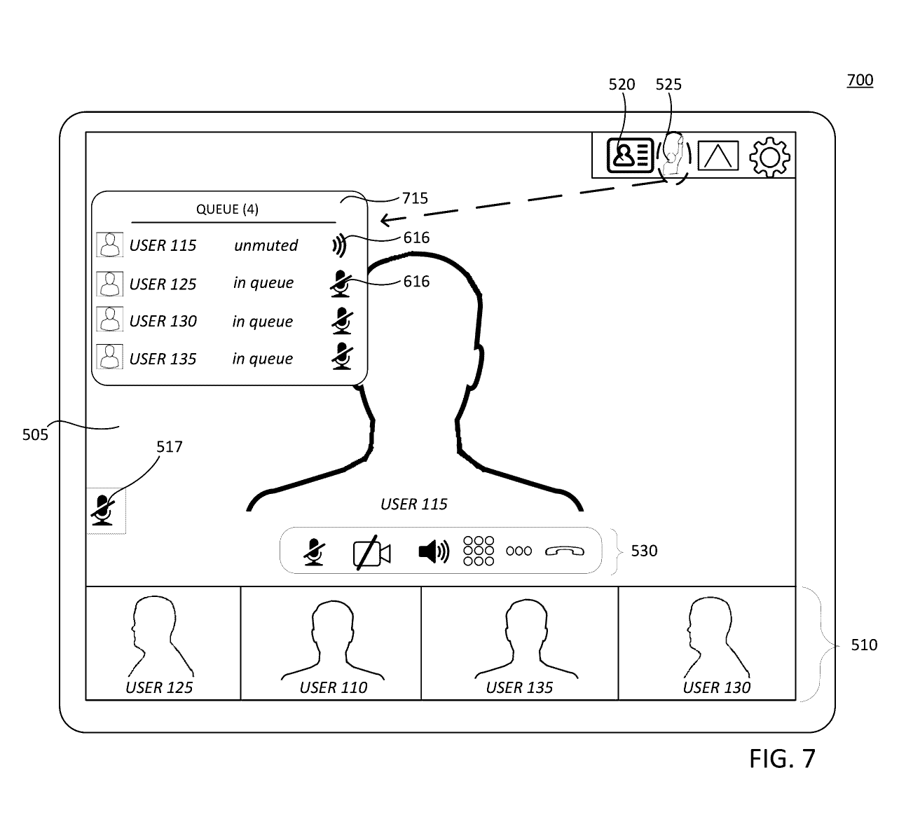

FIG. 7 illustrates an example view 700 of the device shown in FIG. 5, further displaying a participant queue 715 that displays a list of participant devices indexed according to respective assigned queue positions. As discussed above, each device associated with the corresponding participant queue notification 625 in the attendee list 620 is further displayed in the participant queue 715.

Operatively, a user selects the participant request feature 525. The automated participant queueing process receives the request and assigns the requesting participant device to a position in the participant queue 715. Position assignments may be similar to those discussed above with respect to FIGS. 3 and 4.

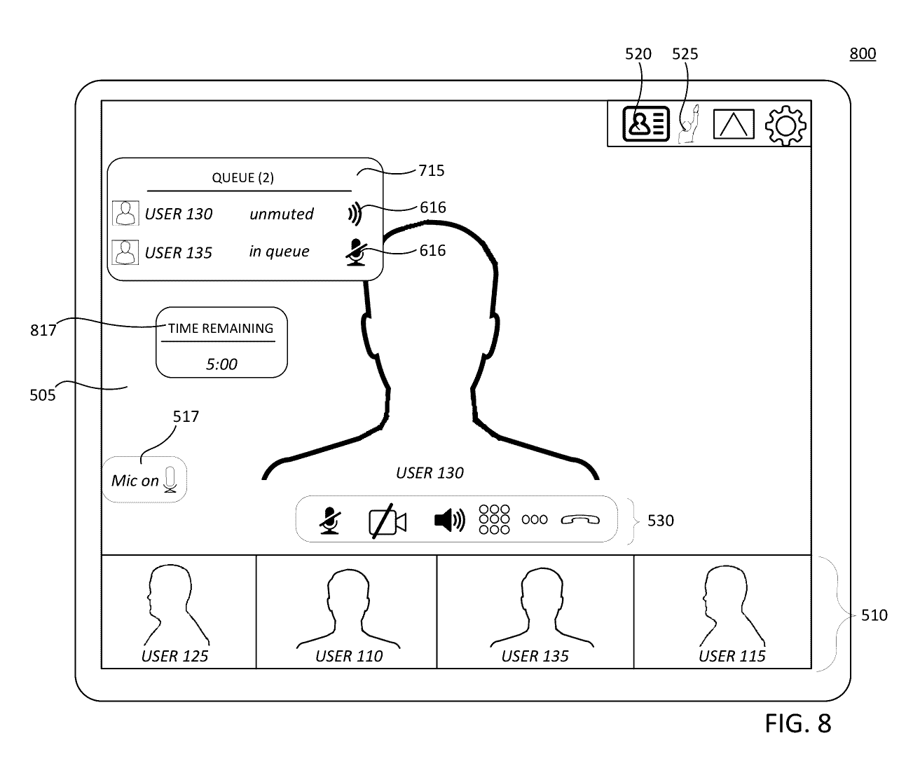

FIG. 8 illustrates an example view 800 of the device shown in FIG. 5, further showing the interaction notification 517 indicating permitted interaction, and an optional timer feature 817. As shown interaction notification 517 in FIG. 8 shows that interaction is permitted—e.g., “Mic on”. Operatively, when the participant device—here, user 130—reaches the top or first position in the participant queue, the automated participant queueing process permits that user/device to interact or participate with the attendees during the communication session. Interaction notification 517 changes from a “mute” icon (FIG. 7) to a “Mic on” display to indicate to the user that such interaction is now permitted. In addition, shared display area 505 may now display video data for the currently interacting participant device. Further, as is appreciated by those skilled in the art, such icons or display features can any number of icons or display features—the particular mute/un-mute/mic-on icons shown in the drawings are for purposes of illustration, not limitation.

View 800 further includes the optional timer feature 817, which can provide guidance to the currently interacting device/user an appropriate or recommended time-period for interaction. In some embodiments, the automated participant queueing process may limit the interaction time according to the timer feature 817 and automatically terminate the interaction of the user once the timer feature 817 indicates the time period is over. Such timer feature 817 can also be configured by a host device (or any other device) at any time and for any time period.

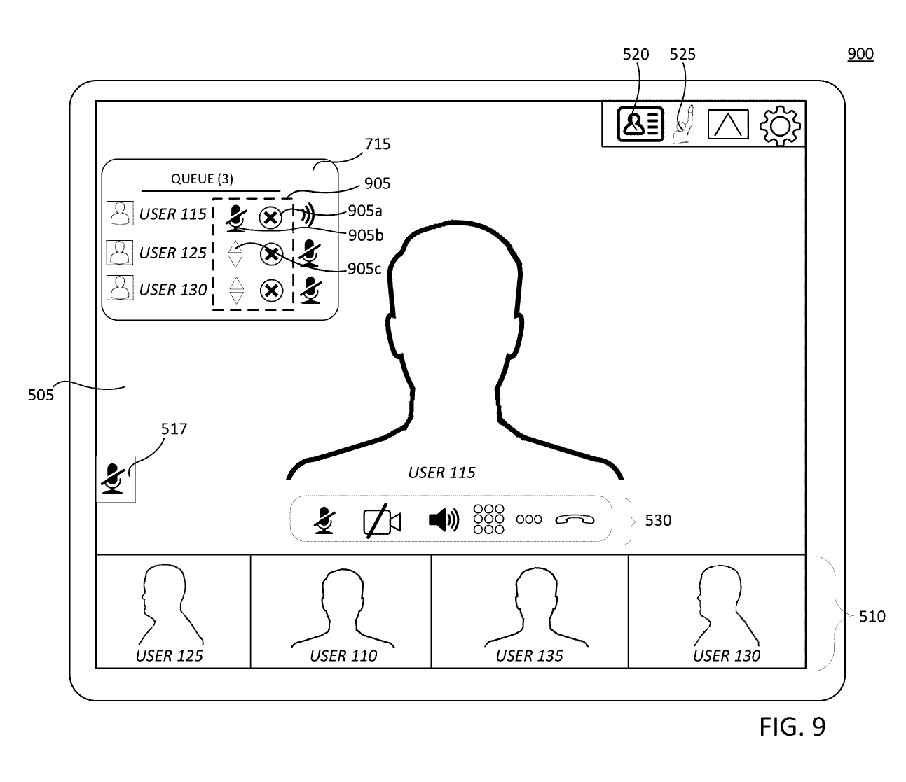

FIG. 9 illustrates an example view 900 of the device techniques shown in FIG. 5, particularly from the perspective of a host user device. As shown in view 900, the host device, similar to view 400, includes host permission features 905. The host permission features 905 include, for example, “remove” 905a, “interact” 905b, “queue position adjust” 905c. As shown, a host user, using a host device, may manipulate the participant queue 715, by, for example, removing certain participant devices (via remove 905a), muting or un-muting participant devices in the participant queue 715 (via interact 905b) to permit or prohibit interaction for the corresponding participant device, and adjust a position assigned to participant devices in the participant queue 715 (via queue position adjust 905c) to move a participant up or down the queue. These host permission features 905 particularly include the above discussed features, however, such features are provided for illustration, not limitation. The host permission features 905 can also include any number of additional features as is understood by those skilled in the art.

Collectively referring to FIGS. 5, 6, 7, 8 and 9, the automated queuing process can be configured to permit or prohibit user interaction according to the participant queue 715, or alternatively, the automated queuing process can be configured to provide supplemental or suggested orderly interaction whereby users, using user features 530, can manually bypass the participant queue 715 and speak or interact ad-hoc.

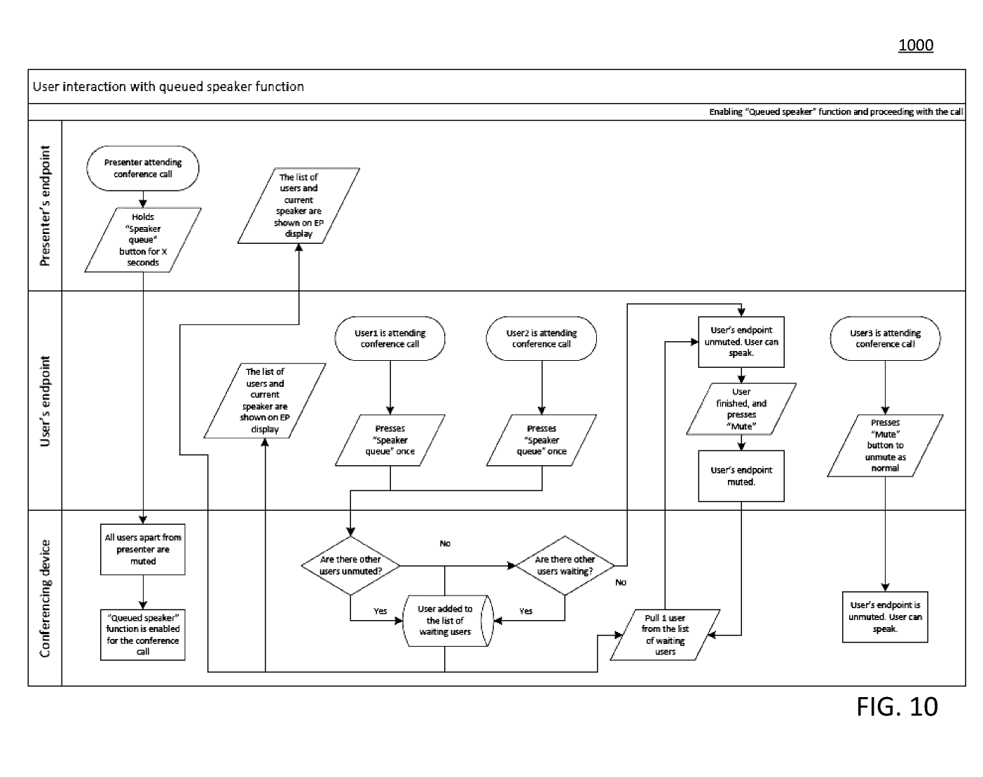

FIG. 10 illustrates an example simplified procedure 1000 for organizing real-time communication sessions for user devices during a real-time communication session. As shown procedure 1000 includes the three (3) different perspectives—a presenter's endpoint, a user's endpoint, and a conferencing device.

From the presenter's endpoint perspective, a presenter attends a conference call and holds the “speaker queue” button (e.g., participant request feature(s) 325 and/or 525) for a period of time—“x” seconds. Operatively, this may initiate the automated participant queueing process, as discussed above. Following the speaker queue command, from the conferencing device(s) perspective, all users apart from the presenter are muted and may now use the participant queue for subsequent interaction.

From the user's endpoint perspective, users 1 and users 2 attend a conference call. When the automated participant queueing process is enabled/initiated, the users select or press the speaker queue button once to be assigned a position on the participant queue. Once assigned to the participant queue, the conferencing device makes a decision to determine when to permit interaction for the participant devices assigned to respective positions on the participant queue. Once a participant device reaches the appropriate position on the participant queue, the automated participant queueing process permits interaction—e.g., “User's endpoint unmuted. User can speak”. When the user is finished interacting—here, speaking, the user selects the “mute” button to signal to the automated queuing process that the user has ceased interaction. In turn, the automated queuing process updates the participant queue, removes the just-finished user, and proceeds to select the next-in-line user from the participant queue for interaction “Pull 1 user from the list of waiting users”.

As discussed above, in certain embodiments, the automated queueing list may provide recommended orderly interaction. As shown in procedure 800, another user—user 3 may attend the conference call and may be able to override the participant queue and participate or interact ad-hoc: “presses ‘mute’ button to unmute as normal”. In certain embodiments, the override features may be available for select users—e.g., presenters, hosts, etc.—or it may depend on timing—a user joins the conference after the automated queuing process is initiated for the then-attending devices.

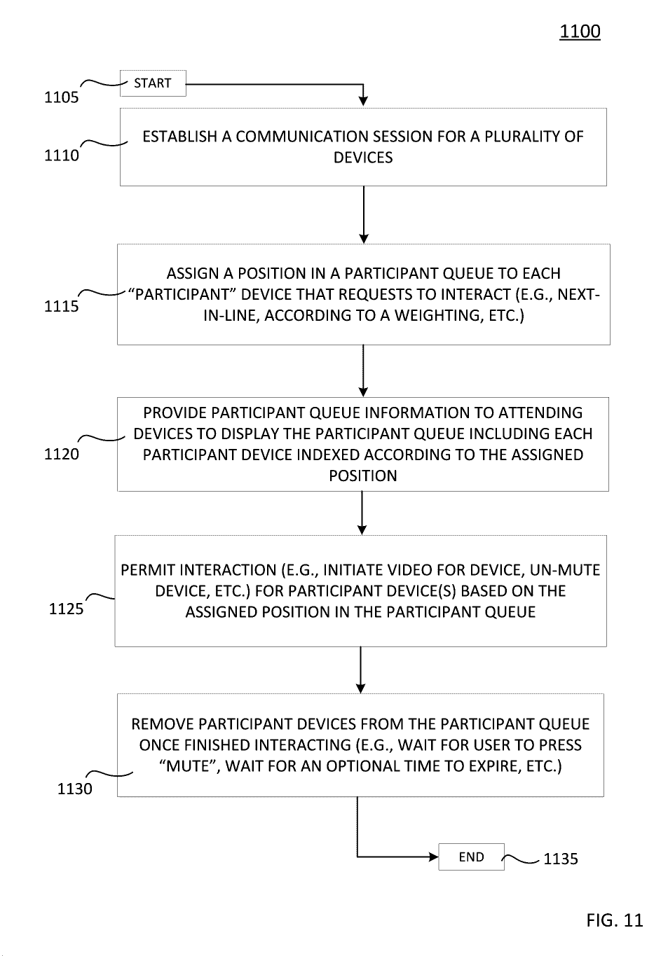

FIG. 11 illustrates another example simplified procedure 1100 for organizing real-time communication sessions for user devices during a real-time communication session. In particular, procedure 1100 illustrates features of the automated participant queueing process, similar to those discussed above. The automated participant queueing process can be executed by any number of devices for a communication session, e.g., one of the use devices, a host device, etc.

The automated participant queueing process shown in procedure 1100 begins at step 1105, and continues to step 1110, where, as described in greater detail above, a communication session is established for a plurality of devices (e.g., attendee devices). In step 1115, procedure 1100 assigns each device requesting to interact (e.g., a “participant device”) a position in a participant queue. For example, as discussed above, the position can be a next-in-line, or it may consider weighting factors.

Further, procedure 1120 provides the participant queue information to the attending devices for subsequent display. For example, the attending devices can display the participant queue, which include each participant device indexed according to the respective assigned position. In other embodiments discussed above, the participant queue may be provided to a sub-set of devices (e.g., only those “participant devices”).

Procedure 1100 continues to step 1125 where a participant device is permitted to interact with the attendee devices according to the assigned position in the participant queue—e.g., once the participant devices reaches the top or first position in the participant queue.

As discussed above, the participant queue can be continuously updated, shown in step 1130. When a currently participating user finishes interacting, the user/device can be removed from the participant queue. Determining when the user is finished interacting can include receiving a user-command such as a “mute” command to indicate the user is finished, or alternatively, an optional timer feature can be used whereby the user is finished interacting at the expiration of a time-period.

Procedure 1100 subsequently ends at step 1135, but may continue again to step 1115 where the automated participant queueing process assigns devices positions in the participant queue.

It should be noted that while certain steps within procedures 1000-1100 may be optional as described above, the steps shown in FIGS. 10-11 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 1000-1100 are described separately, certain steps from each procedure may be incorporated into each other procedure, and the procedures are not meant to be mutually exclusive.

The techniques described herein, therefore, provide for an automated queueing process (e.g., the automated participant queueing process) that organizes real-time communication sessions using, for example, a participant queue (amongst other features). Such automated queueing process, as described above, is flexible and may also allow users to over-ride the participant queue and interact ad-hoc. Further, the automated queueing process may be enabled or disabled at any time during the communication session.

While there have been shown and described illustrative embodiments that provide for collaboration amongst users, it is to be understood that various other adaptations and modifications may be made within the spirit and scope of the embodiments herein. For example, the embodiments have been shown and described herein with relation to two users with associated devices (e.g., computers/tablets/mobile devices, etc.). However, the embodiments in their broader sense are not as limited, and may, in fact, be used with any number of users/devices and the like.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly this description is to be taken only by way of example and not to otherwise limit the scope of the embodiments herein. Therefore, it is the object of the appended claims to cover all such variations and modifications as come within the true spirit and scope of the embodiments herein.

1. A method, comprising:
receiving, by a host device, an interaction request from at least one participant device during a communication session between a plurality of devices;
assigning, by the host device, a position in a participant queue to each participant device;
providing, by the host device, information regarding the participant queue to one or more of the plurality of devices to cause each of the one or more devices to display the participant queue including each participant device indexed according to the assigned position; and
permitting, by the host device, at least one participant device to interact with the plurality of devices of the communication session according to the assigned position in the participant queue.

2. The method of claim 1, further comprising:
providing, by the host device, an interaction notification to at least one participant device indicating that the at least one participant device is permitted to interact with the plurality of devices of the communication session according to the position assigned to the at least one participant device in the participant queue.

3. The method of claim 2, wherein the interaction notification further indicates that the at least one participant device is not permitted to interact with the plurality of devices of the communication session according to the position assigned to the at least one participant device in the participant queue.

4. The method of claim 1, wherein providing, by the host device, the information regarding the participant queue further comprises providing information regarding the participant queue to each participant device associated with an assigned position in the participant queue.

5. The method of claim 1, further comprising:
removing, by the host device, each participant device of the at least one participant devices from the participant queue when the participant device ceases permitted interaction with the plurality of devices of the communication session.

6. The method of claim 1, wherein assigning, by the host device, the position in the participant queue to each participant device further comprises:
determining a weighting based on at least one of a total time spoken during the communication session, a number of times spoken during the communication session, a subject matter of the communication session, or a position within a company; and
assigning, by the host device, the position in the participant queue for at least one participant device based on the weighting.

7. The method of claim 1, further comprising:
establishing, by the host device, a time period to permit the at least one participant device to interact with the plurality of devices of the communication session, and
wherein, permitting the at least one participant device to interact with the plurality of devices of the communication session is further comprises permitting the at least one participant device to interact with the plurality of devices of the communication session according to the time period.

8. The method of claim 7, further comprising:
providing, by the host device, information regarding the time period to one or more of the plurality of devices to cause each of the one or more devices to display the time period for which the at least one participant device is permitted to interact with the plurality of devices of the communication session.

9. The method of claim 1, wherein, permitting, by the host device, the at least one participant device to interact with the plurality of devices of the communication session comprises at least one of un-muting the at least one participant device, or displaying video data for the at least one participant device.

10. A device, comprising:
one or more network interfaces to communicate with a plurality of devices during a communication session in a communication network;
a processor coupled to the network interfaces and adapted to execute one or more processes; and
a memory configured to store a process executable by the processor, the process when executed operable to:
receive an interaction request from at least one participant device during the communication;
assign a position in a participant queue to each participant device;
provide information regarding the participant queue to one or more of the plurality of devices to cause each of the one or more devices to display the participant queue including each participant device indexed according to the assigned position; and
permit at least one participant device to interact with the plurality of devices of the communication session according to the assigned position in the participant queue.

11. The device of claim 10, wherein the process, when executed by the processor, is further operable to:
provide an interaction notification to at least one participant device indicating that the at least one participant device is permitted to interact with the plurality of devices of the communication session according to the position assigned to the at least one participant device in the participant queue.

12. The device of claim 11, wherein the interaction notification further indicates that the at least one participant device is not permitted to interact with the plurality of devices of the communication session according to the position assigned to the at least one participant device in the participant queue.

13. The device of claim 10, wherein the process to provide the information regarding the participant queue, when executed by the processor, is further operable to provide information regarding the participant queue to each participant device associated with an assigned position in the participant queue.

14. The device of claim 10, wherein the process, when executed by the processor, is further operable to:
remove each participant device of the at least one participant devices from the participant queue when the participant device ceases permitted interaction with the plurality of devices of the communication session.

15. The device of claim 10, wherein the process to assign the position in the participant queue to each participant device, when executed by the processor, is further operable to:
determine a weighting based on at least one of a total time spoken during the communication session, a number of times spoken during the communication session, a subject matter of the communication session, or a position within a company; and
assign the position in the participant queue for at least one participant device according to the weighting.

16. The device of claim 10, wherein the process, when executed by the processor, is further operable to:
establish a time period to permit the at least one participant device to interact with the plurality of devices of the communication session, and
wherein, permitting the at least one participant device to interact with the plurality of devices further comprises permitting the at least one participant device to interact with the plurality of devices according to the time period.

17. The device of claim 16, wherein the process, when executed by the processor, is further operable to:
provide information regarding the time period to one or more of the plurality of devices to cause each of the one or more devices to display the time period for which the at least one participant device is permitted to interact with the plurality of devices of the communication session.

18. The device of claim 10, wherein the process to permit the at least one participant device to interact with the plurality of devices of the communication session, when executed by the processor, is further operable to un-mute the at least one participant device, or display video data for the at least one participant device.

19. A tangible, non-transitory, computer-readable media having software encoded thereon, the software, when executed by a processor, operable to:
receive an interaction request from at least one participant device during a communication session between a plurality of devices;
assign a position in a participant queue to each participant device;
provide information regarding the participant queue to one or more of the plurality of devices to cause each of the one or more devices to display the participant queue including each participant device indexed according to the assigned position; and
permit at least one participant device to interact with the plurality of devices of the communication session according to the assigned position in the participant queue.

20. The computer-readable media of claim 19, wherein the software, when executed by the processor, is further operable to:
determine a weighting based on at least one of a total time spoken during the communication session, a number of times spoken during the communication session, a subject matter of the communication session, or a position within a company; and
assign the position in the participant queue for at least one participant device according to the weighting.
